(19) United States
(12) Patent Application Publication
(10) Pub. No.: US 2026/0279664 A1
(43) Pub. Date: Sep. 17, 2026

(54) ELECTRONIC COMPONENT

(71) Applicant: TDK Corporation, Tokyo (JP)

(72) Inventors: Keiichi TAKIZAWA, Tokyo (JP); Ryo KONNO, Tokyo (JP); Yoshitaka NAGASHIMA, Tokyo (JP); Toshihiro IGUCHI, Tokyo (JP); Kenichi KAMEHASHI, Tokyo (JP)

(73) Assignee: TDK Corporation, Tokyo (JP)

(21) Appl. No.: 19/564,591

(22) Filed: Mar. 12, 2026

(30) Foreign Application Priority Data
Mar. 13, 2025 (JP) 2025-040404

(51) Int. Cl. H01G 4/005; H01G 4/224; H01G 4/232; H01G 4/248; H01G 4/30

(52) U.S. Cl. CPC H01G 4/005; H01G 4/224; H01G 4/232; H01G 4/248; H01G 4/30

(57) ABSTRACT

An extended portion of an electronic component includes a first rectangular portion, a second rectangular portion, and a coupling portion. The first rectangular portion is coupled to a first external electrode and has a rectangular shape. The second rectangular portion is coupled to a main body portion and has a rectangular shape. The coupling portion couples the first rectangular portion and the second rectangular portion. In a third direction intersecting first and second directions, the width of the first rectangular portion is smaller than the width of the main body portion. In the third direction, the width of the second rectangular portion is larger than the width of the first rectangular portion. The width of the coupling portion in the third direction is formed to be narrower toward the first rectangular portion.

### TECHNICAL FIELD

The present disclosure relates to an electronic component.

### BACKGROUND

An electronic component in which a plurality of internal electrodes are provided inside an element body is known (for example, Japanese Unexamined Patent Publication No. 2008-166666). The electronic component further includes a pair of external electrodes provided outside the element body and electrically connected to the plurality of internal electrodes. The plurality of internal electrodes include first and second internal electrodes opposed to each other. The pair of external electrodes includes a first external electrode electrically connected to the first internal electrode and a second external electrode connected to the second internal electrode.

The first internal electrode includes a main body portion and an extended portion. The main body portion overlaps the second internal electrode when viewed from an opposing direction to the second internal electrode. The extended portion does not overlap the second internal electrode when viewed from the opposing direction, extends in a direction intersecting the opposing direction, and couples the first external electrode and the main body portion. In this case, when the plating treatment is performed, the larger the portion where the extended portion and the first external electrode are connected, the greater the risk that the plating solution enters the inside of the element body through a gap between the extended portion and the element body. When the plating solution enters the inside of the element body, cracks may occur in the element body when the electronic component is used.

As the first internal electrode is made smaller as a whole in order to reduce the portion where the extended portion and the first external electrode are connected, the electrostatic capacitance generated between the first internal electrode and the second internal electrode also decreases. Therefore, it is conceivable to make the width of the extended portion smaller than the width of the main body portion. However, as a result of investigation and research, the present inventors have found a new fact that when the widths of the extended portion and the main body portion are different, there is a possibility that a crack is caused in the element body in the vicinity of the connection portion between the extended portion and the main body portion. In particular, it has been found that when a thermal shock is generated in the electronic component 1, the maximum principal stress applied to the element body is generated in the vicinity of the connection portion between the extended portion and the main body portion.

One aspect of the present disclosure relates to an electronic component capable of preventing occurrence of a crack in an element body while securing electrostatic capacitance.

### SUMMARY

An electronic component according to one aspect of the present disclosure includes an element body, first and second internal electrodes, and first and second external electrodes. The first and second internal electrodes are provided inside the element body and are opposed to each other in a first direction. The first external electrode is provided outside the element body and is electrically connected to the first internal electrode. The second external electrode is provided outside the element body separately from the first external electrode, and is electrically connected to the second internal electrode. The first internal electrode includes a main body portion and an extended portion. The main body portion overlaps the second internal electrode in the first direction. The extended portion does not overlap the second internal electrode when viewed from the first direction, extends in a second direction intersecting the first direction, and couples the first external electrode and the main body portion. The extended portion includes a first rectangular portion, a second rectangular portion, and a coupling portion. The first rectangular portion is coupled to the first external electrode and has a rectangular shape. The second rectangular portion is coupled to the main body portion and has a rectangular shape. The coupling portion couples the first rectangular portion and the second rectangular portion. In a third direction intersecting the first and second directions, the width of the first rectangular portion is smaller than the width of the main body portion. In the third direction, the width of the second rectangular portion is larger than the width of the first rectangular portion. The width of the coupling portion in the third direction is formed to be narrower toward the first rectangular portion.

### BRIEF DESCRIPTION OF THE DRAWINGS

FIG. 1 is a perspective view of an electronic component according to the present embodiment;

FIG. 2 is a cross-sectional view of the electronic component according to the present embodiment;

FIG. 3 is a cross-sectional view of the electronic component according to the present embodiment;

FIG. 4 is a partial cross-sectional view of the electronic component according to the present embodiment;

FIG. 5 is a graph illustrating a relationship between the length of the second rectangular portion and the maximum principal stress applied to the element body;

FIG. 6 is a graph illustrating a relationship between the gradient of the coupling portion and the maximum principal stress applied to the element body;

FIG. 7 is a graph illustrating a relationship between the drawing ratio and the maximum principal stress applied to the element body;

FIG. 8 is a table illustrating various conditions set in the simulation of the stress applied to the element body;

FIG. 9 is a diagram for explaining a mesh used when the stress applied to the element body is simulated; and

FIG. 10 is a diagram for explaining a mesh used when the stress applied to the element body is simulated.

### DETAILED DESCRIPTION

Hereinafter, embodiments of the present disclosure will be described in detail with reference to the accompanying drawings. In the description of the drawings, the same reference numerals are used for the same or equivalent elements, and redundant description will be omitted.

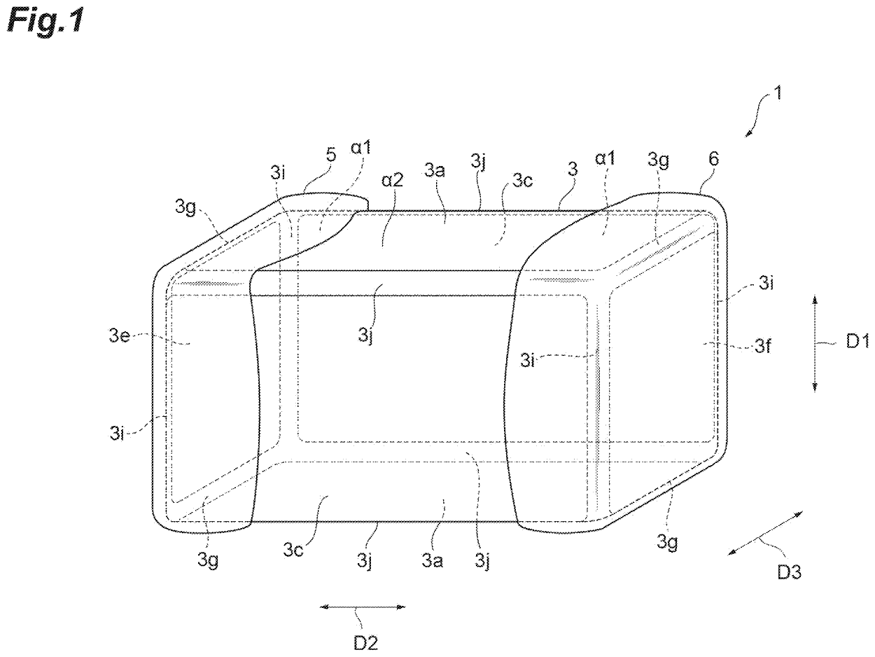

First, an electronic component according to the present embodiment will be described with reference to FIGS. 1 to 3. In the example illustrated in the present embodiment, the electronic component is, for example, a stacked electronic component. An electronic component 1 is formed by stacking a plurality of layers. The boundaries between the layers are integrated to such an extent that the boundaries cannot be visually recognized, for example. The electronic component 1 is, for example, a multilayer capacitor.

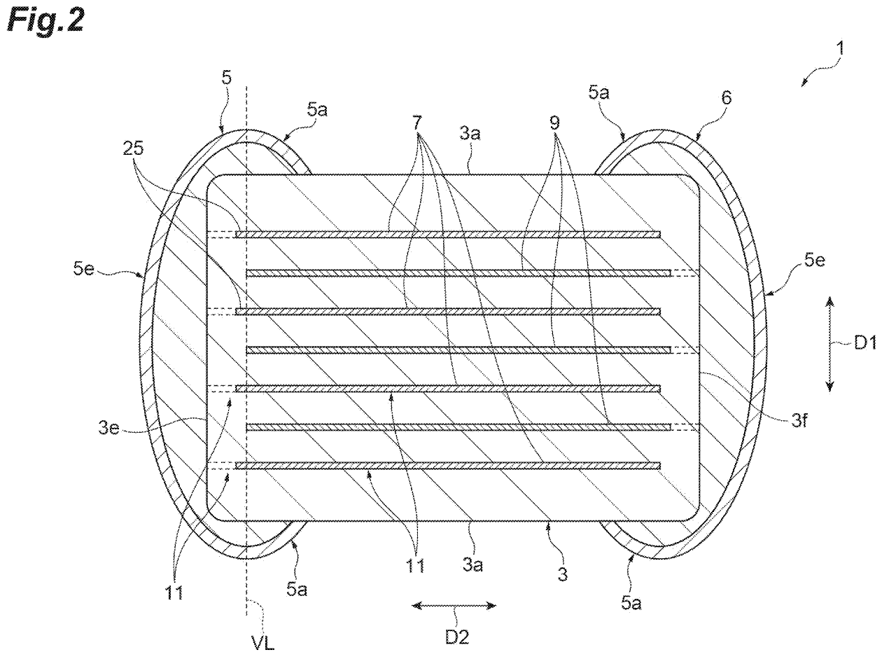

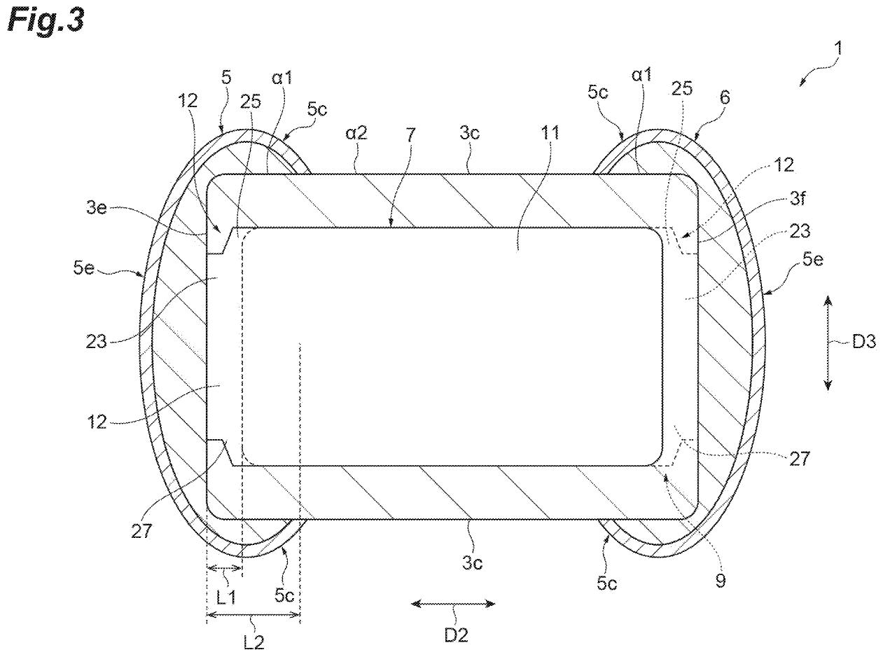

FIG. 1 is a perspective view of the electronic component 1 in an example illustrated in the present embodiment. FIG. 2 is a cross-sectional view of the electronic component 1 according to the present embodiment taken along a virtual line VL. FIG. 3 is a partial cross-sectional view of the electronic component 1 according to the present embodiment.

As illustrated in FIG. 1, the electronic component 1 includes an element body 3 having a rectangular parallelepiped shape and a pair of external electrodes 5 and 6. In the present embodiment, the electronic component 1 includes a pair of external electrodes 5 and 6. The pair of external electrodes 5 and 6 is provided outside the element body 3 and is disposed on the outer surface of the element body 3. The pair of external electrodes 5 and 6 is separated from each other. The rectangular parallelepiped shape includes a rectangular parallelepiped shape in which the corner portions and the ridge portions are chamfered, and a rectangular parallelepiped shape in which the corner portions and the ridge portions are rounded.

The element body 3 has a pair of side surfaces 3a opposed to each other, a pair of side surfaces 3c opposed to each other, and a pair of end surfaces 3e and 3f opposed to each other. The pair of side surfaces 3a, the pair of side surfaces 3c, and the pair of end surfaces 3e and 3f each have a rectangular shape. The direction in which the pair of side surfaces 3a is opposed to each other is a first direction D1. The direction in which the pair of side surfaces 3c is opposed to each other is a third direction D3. The direction in which the pair of end surfaces 3e and 3f is opposed to each other is a second direction D2. The pair of side surfaces 3a and the pair of side surfaces 3c are located between the pair of end surfaces 3e and 3f when viewed from a direction orthogonal to the second direction. The electronic component 1 is solder-mounted to an electronic device. The electronic device includes, for example, a circuit board or an electronic component. In the electronic component 1, one side surface 3a faces the electronic device. The one side surface 3a is disposed so as to constitute a mounting surface. The one side surface 3a is the mounting surface. The end surface 3e corresponds to a first end surface, and the end surface 3f corresponds to a second end surface.

The first direction D1 is a direction orthogonal to each side surface 3a, and is orthogonal to the third direction D3. The second direction D2 is a direction parallel to each side surface 3a and each side surface 3c, and is orthogonal to the first direction D1 and the third direction D3. The third direction D3 is a direction orthogonal to each side surface 3c, and the second direction D2 is a direction orthogonal to each end surface 3e. In the present embodiment, the length of the element body 3 in the second direction D2 is larger than the length of the element body 3 in the first direction D1, and is larger than the length of the element body 3 in the third direction D3. The second direction D2 is the longitudinal direction of the element body 3. The length of the element body 3 in the first direction D1 and the length of the element body 3 in the third direction D3 may be equal to each other. The length of the element body 3 in the first direction D1 and the length of the element body 3 in the third direction D3 may be different from each other.

The length of the element body 3 in the first direction D1 is the height of the element body 3. The length of the element body 3 in the third direction D3 is the width of the element body 3. The length of the element body 3 in the second direction D2 is the length of the element body 3. In the present embodiment, the height of the element body 3 is 0.1 mm to 2.5 mm, the width of the element body 3 is 0.1 mm to 5.0 mm, and the length of the element body 3 is 0.2 mm to 5.7 mm. For example, the height of the element body 3 is 2.5 mm, the width of the element body 3 is 2.5 mm, and the length of the element body 3 is 3.2 mm.

The pair of side surfaces 3c extends in the first direction D1 so as to couple the pair of side surfaces 3a to each other. The pair of side surfaces 3c also extends in the second direction D2. The pair of end surfaces 3e extends in the first direction D1 so as to couple the pair of side surfaces 3a to each other. The pair of end surfaces 3e also extends in the third direction D3.

The element body 3 includes four ridge portions 3g, four ridge portions 3i, and four ridge portions 3j. Each ridge portion 3g is located between the end surface 3e and the side surface 3a. Each ridge portion 3i is located between the end surface 3e and the side surface 3c. Each ridge portion 3j is located between the side surface 3a and the side surface 3c. In the present embodiment, each of the ridge portions 3g, 3i, and 3j is rounded so as to be curved. The element body 3 is subjected to so-called round chamfering. The end surface 3e and the side surface 3a are indirectly adjacent to each other via the ridge portion 3g. The end surface 3e and the side surface 3c are indirectly adjacent to each other via the ridge portion 3i. The side surface 3a and the side surface 3c are indirectly adjacent to each other via the ridge portion 3j.

The element body 3 is formed by stacking a plurality of dielectric layers in the first direction D1. The element body 3 has a plurality of stacked dielectric layers. In the element body 3, the direction in which the plurality of dielectric layers are stacked coincides with the first direction D1. Each of the dielectric layers includes, for example, a sintered body of a ceramic green sheet containing a dielectric material. The dielectric material includes, for example, a dielectric ceramic such as a BaTiO₃-based, Ba(Ti, Zr)O₃-based, or (Ba, Ca)TiO₃-based ceramic. In the actual element body 3, the dielectric layers are integrated to such an extent that a boundary between the dielectric layers cannot be visually recognized.

As illustrated in FIGS. 2 and 3, the electronic component 1 further includes a plurality of internal electrodes 7 and a plurality of internal electrodes 9. Each of the internal electrodes 7 and 9 is an internal conductor provided inside the element body 3. Each of the internal electrodes 7 and 9 is made of a conductive material usually used as an internal conductor of a stacked electronic component. The conductive material contains, for example, a base metal. The conductive material contains, for example, Ni or Cu. The internal electrodes 7 and 9 are configured as sintered bodies of a conductive paste containing the conductive material. In the present embodiment, the internal electrodes 7 and 9 are made of Ni. The internal electrode 7 corresponds to the first internal electrode, and the internal electrode 9 corresponds to the second internal electrode.

The internal electrodes 7 and the internal electrodes 9 are disposed in layers at different positions in the first direction D1. The internal electrodes 7 and the internal electrodes 9 are alternately disposed so as to be opposed to each other with an interval in the first direction D1 inside the element body 3. The internal electrodes 7 and the internal electrodes 9 have different polarities from each other. One end of each of the internal electrodes 7 and 9 is exposed to the corresponding end surfaces 3e and 3f. The internal electrodes 7 and 9 include one end exposed to the corresponding end surfaces 3e and 3f.

The plurality of internal electrodes 7 and the plurality of internal electrodes 9 are alternately arranged in the first direction D1. The plurality of internal electrodes 7 and 9 are disposed in the element body 3 so as to be aligned in the first direction D1. Each of the internal electrodes 7 and 9 is located in a plane substantially parallel to the side surface 3c. The internal electrode 7 and the internal electrode 9 are opposed to each other in the first direction D1. The direction in which the internal electrodes 7 and the internal electrodes 9 are opposed to each other is orthogonal to the second direction D2 and the third direction D3 parallel to the side surface 3a.

As illustrated in FIG. 1, the external electrodes 5 and 6 are respectively disposed at both end portions of the element body 3 in the second direction D2, respectively. Each of the external electrodes 5 and 6 is disposed on the corresponding end surface side of the pair of end surfaces 3e and 3f. In the present embodiment, the external electrode 5 is provided on the pair of side surfaces 3a, the pair of side surfaces 3c, and the end surface 3e, and the external electrode 6 is provided on the pair of side surfaces 3a, the pair of side surfaces 3c, and the end surface 3f. The external electrode 5 extends from the end surface 3e toward the end surface 3f on the pair of side surfaces 3a and the pair of side surfaces 3c. The external electrode 6 extends from the end surface 3f toward the end surface 3e on the pair of side surfaces 3a and the pair of side surfaces 3c. The pair of side surfaces 3a and the pair of side surfaces 3c include a first portion α1 covered with the external electrodes 5 and 6 and a second portion α2 not covered with the external electrodes 5 and 6.

Each of the external electrodes 5 and 6 has a plurality of electrode portions 5a, 5c, and 5e. FIGS. 2 and 3 illustrate the plurality of electrode portions 5a, 5c, and 5e of the external electrode 5 as an example. The electrode portion 5a is disposed on the side surface 3a and the ridge portion 3g. Each electrode portion 5c is disposed on the side surface 3c and the ridge portion 3i. The electrode portion 5e is disposed on the end surfaces 3e and 3f. Each of the external electrodes 5 and 6 also has an electrode portion disposed on the ridge portion 3j.

The pair of external electrodes 5 and 6 is provided on the five surfaces consisting of the pair of side surfaces 3a, the one end surface 3e, and the pair of side surfaces 3c, and on the ridge portions 3g, 3i, and 3j. The electrode portions 5a, 5c, and 5e adjacent to each other are connected and electrically connected. The electrode portion 5e covers all the one ends of the corresponding internal electrodes 7 and 9. The electrode portion 5e is directly connected to the corresponding internal electrodes 7 and 9 of the plurality of internal electrodes 7 and 9. Each of the external electrodes 5 and 6 is electrically connected to the corresponding internal electrodes 7 and 9 of the plurality of internal electrodes 7 and 9. Each of the external electrodes 5 and 6 includes a first electrode layer E1 and a second electrode layer E2. The second electrode layer E2 constitutes the outermost layer of each of the external electrodes 5 and 6. Each of the electrode portions 5a, 5c, and 5e includes the first electrode layer E1 and the second electrode layer E2.

The first electrode layer E1 of the electrode portion 5a is disposed on the side surface 3a and the ridge portion 3g. The first electrode layer E1 of the electrode portion 5a is formed so as to cover a part of the side surface 3a and the entire ridge portion 3g. The first electrode layer E1 of the electrode portion 5a is in contact with the part of the side surface 3a and the entire ridge portion 3g. The side surface 3a is covered with the first electrode layer E1 in the part, and is exposed from the first electrode layer E1 in the remaining portion other than the part. The part of the side surface 3a is a partial region of the side surface 3a closer to the end surface 3e.

The second electrode layer E2 of the electrode portion 5a is disposed on the first electrode layer E1 and the side surface 3a. In the electrode portion 5a, the second electrode layer E2 covers the entire first electrode layer E1. In the electrode portion 5a, the second electrode layer E2 is in contact with the first electrode layer E1. The second electrode layer E2 of the electrode portion 5a is located on the side surface 3a. The electrode portion 5a has a two-layer structure.

The first electrode layer E1 of the electrode portion 5c is disposed on the side surface 3c and the ridge portion 3i. The first electrode layer E1 of the electrode portion 5c is formed so as to cover a part of the side surface 3c and the entire ridge portion 3i. The first electrode layer E1 of the electrode portion 5c is in contact with the part of the side surface 3c and the entire ridge portion 3i. The side surface 3c is covered with the first electrode layer E1 in the part, and is exposed from the first electrode layer E1 in the remaining portion. The part of the side surface 3c is a partial region of the side surface 3c closer to the end surface 3e. The first electrode layer E1 of the electrode portion 5c is located on the side surface 3c.

The second electrode layer E2 of the electrode portion 5c is disposed on the first electrode layer E1 and the side surface 3c. In the electrode portion 5c, the second electrode layer E2 covers the entire first electrode layer E1. In the electrode portion 5c, the second electrode layer E2 is in contact with the entire first electrode layer E1. The second electrode layer E2 of the electrode portion 5c is located on the side surface 3c. The electrode portion 5c has a two-layer structure.

A part of the electrode portion 5c constitutes, for example, a side-surface electrode portion. The part of the electrode portion 5c is, for example, a portion included in the electrode portion 5c and located on the side surface 3c. In the part of the electrode portion 5c, the first electrode layer E1 is directly in contact with the side surface 3c.

The first electrode layer E1 of the electrode portion 5e is disposed on the end surface 3e. The first electrode layer E1 of the electrode portion 5e is formed so as to cover the entire end surface 3e. The first electrode layer E1 of the electrode portion 5e is in contact with the entire end surface 3e.

The second electrode layer E2 of the electrode portion 5e is disposed on the first electrode layer E1. In the electrode portion 5e, the second electrode layer E2 covers the entire first electrode layer E1. In the electrode portion 5e, the second electrode layer E2 is in contact with the entire first electrode layer E1. The second electrode layer E2 of the electrode portion 5e is located on the end surface 3e. The electrode portion 5e has a two-layer structure. The electrode portion 5e constitutes, for example, an end-surface electrode portion.

The first electrode layer E1 is formed by baking a conductive paste applied to the surface of the element body 3. The first electrode layer E1 is formed so as to cover the part of the side surface 3a, the part of the side surface 3c, one end surface 3e, and the ridge portions 3g, 3i, and 3j. The first electrode layer E1 is formed by sintering a metal component (metal particles) contained in the conductive paste. The first electrode layer E1 is a sintered metal layer. The first electrode layer E1 is a sintered metal layer formed on the element body 3. In the present embodiment, the first electrode layer E1 is a sintered metal layer made of Cu. The first electrode layer E1 may be a sintered metal layer made of Ni. The first electrode layer E1 contains a base metal. The conductive paste contains, for example, particles made of Cu or Ni, a glass component, an organic binder, and an organic solvent. The first electrode layer E1 included in each of the electrode portions 5a, 5c, and 5e is integrally formed.

The second electrode layer E2 is formed on the first electrode layer E1 by a plating method. The second electrode layer E2 may have a multilayer structure. In this case, the second electrode layer E2 includes, for example, a Ni plating layer and a solder plating layer. The Ni plating layer is formed on the first electrode layer E1. The solder plating layer is formed on the Ni plating layer. The solder plating layer covers the Ni plating layer. The second electrode layer E2 may have a Sn plating layer, a Cu plating layer, or an Au plating layer instead of the Ni plating layer. The solder plating layer includes, for example, a Sn plating layer, a Sn—Ag alloy plating layer, a Sn—Bi alloy plating layer, or a Sn—Cu alloy plating layer. The second electrode layer E2 included in each of the electrode portions 5a, 5c, and 5e is integrally formed.

Next, the plurality of internal electrodes 7 and the plurality of internal electrodes 9 will be described in detail. The plurality of internal electrodes 7 are electrically connected to the external electrode 5 on the end surface 3e. The plurality of internal electrodes 9 are electrically connected to the external electrode 6 on the end surface 3f. Each of the internal electrodes 7 and 9 includes a main body portion 11 and an extended portion 12. The main body portion 11 of the internal electrode 7 and the main body portion 11 of the internal electrode 9 overlap each other in the first direction D1. In other words, the main body portion 11 of the internal electrode 7 overlaps the internal electrode 9 in the first direction D1. The main body portion 11 of the internal electrode 9 overlaps the internal electrode 7 in the first direction D1. Moreover, in other words, the main body portion 11 is a portion where the internal electrodes 7 and 9 electrically connected to the different external electrodes 5 and 6 overlap each other. The main body portion 11 is a portion where the internal electrodes 7 and 9 adjacent to each other overlap each other in the first direction D1.

The extended portion 12 of the internal electrode 7 couples the main body portion 11 of the internal electrode 7 and the external electrode 5 in the second direction D2. The extended portion 12 of the internal electrode 7 does not overlap the internal electrode 9 when viewed from the first direction D1. The extended portion 12 of the internal electrode 9 couples the main body portion 11 of the internal electrode 9 and the external electrode 6 in the second direction D2. The extended portion 12 of the internal electrode 9 does not overlap the internal electrode 7 when viewed from the first direction D1. Moreover, in other words, the extended portion 12 is a portion where the internal electrodes 7 and 9 electrically connected to the different external electrodes 5 and 6 do not overlap each other. The extended portion 12 is a portion other than the main body portion 11 in each the internal electrodes 7 and 9.

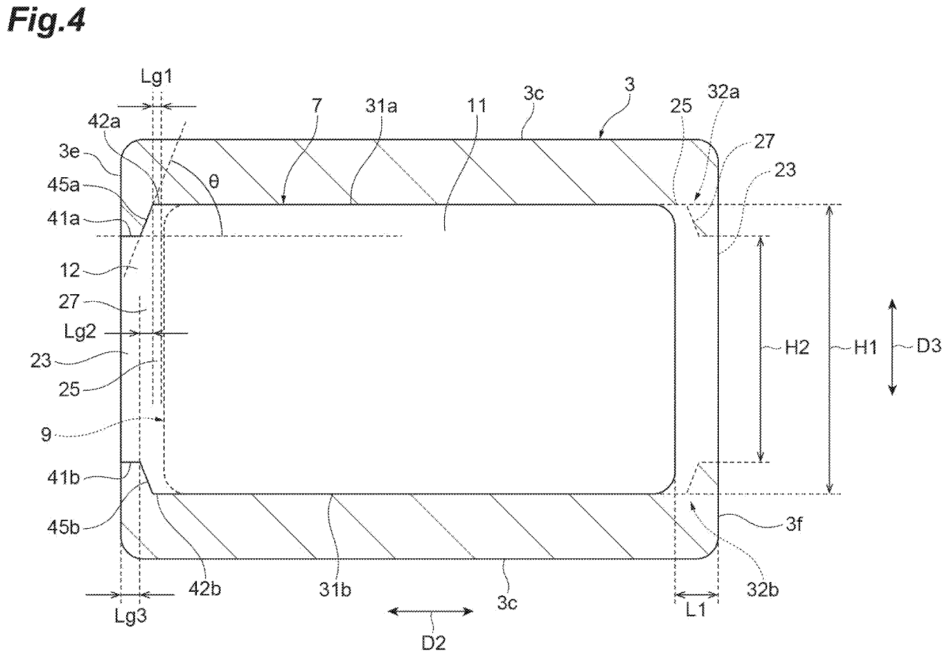

As illustrated in FIG. 4, the extended portion 12 includes a first rectangular portion 23, a second rectangular portion 25, and a coupling portion 27. FIG. 4 is a partial cross-sectional view of the electronic component 1 from which the external electrodes 5 and 6 are removed. The first rectangular portion 23 is coupled to the external electrode 5. The first rectangular portion 23 has a rectangular shape. The first rectangular portion 23 of the internal electrode 7 is coupled to the external electrode 5 on the end surface 3e. The first rectangular portion 23 of the internal electrode 9 is coupled to the external electrode 6 on the end surface 3f.

In the third direction D3, the width H2 of the first rectangular portion 23 is smaller than the width H1 of the main body portion 11. The width H1 of the main body portion 11 is, for example, the maximum width of the main body portion 11 in the third direction D3. The width H2 of the first rectangular portion 23 is, for example, the maximum width of the first rectangular portion 23 in the third direction D3. In the example illustrated in the present embodiment, the width H1 of the main body portion 11 corresponds to the maximum width of the main body portion 11 in the third direction D3. H2/H1 is 0.6 or more and 0.8 or less. H2/H1 is also called a drawing ratio.

The second rectangular portion 25 is coupled to the main body portion 11. The second rectangular portion 25 has a rectangular shape. In the third direction D3, the width H1 of the second rectangular portion 25 is larger than the width H2 of the first rectangular portion 23. The width H1 of the second rectangular portion 25 is the same as the width H1 of the main body portion 11.

The main body portion 11 includes a pair of edges 31a and 31b. The pair of edges 31a and 31b is located on opposite sides in the third direction D3. The pair of edges 31a and 31b extends along the second direction D2. Each of the pair of edges 31a and 31b is, for example, a straight line. The pair of edges 31a and 31b is, for example, parallel to each other. The edges 31a and 31b correspond to, for example, first edges. The extended portion 12 includes a pair of edges 32a and 32b. The pair of edges 32a and 32b extends in the second direction D2 and is located on opposite sides in the third direction D3 when viewed from the first direction D1. Each of the pair of edges 32a and 32b is configured by coupling a plurality of straight lines inclined with respect to each other.

The first rectangular portion 23 includes a pair of edges 41a and 41b. The pair of edges 41a and 41b extends along the second direction D2. The pair of edges 41a and 41b is located on opposite sides in the third direction D3. Each of the pair of edges 41a and 41b is, for example, a straight line. The pair of edges 41a and 41b is, for example, parallel to each other.

The second rectangular portion 25 includes a pair of edges 42a and 42b. The pair of edges 42a and 42b extends along the second direction D2. The pair of edges 42a and 42b is located on opposite sides in the third direction D3. Each of the pair of edges 42a and 42b is, for example, a straight line. The pair of edges 42a and 42b is, for example, parallel to each other. Each of the pair of edges 42a and 42b is located on an extension line of the corresponding edge among the pair of edges 31a and 31b. The edge 42a is located on an extension line of the edge 31a and is continuous with the edge 31a. The edge 42b is located on an extension line of the edge 31b. The edges 42a and 42b correspond to, for example, second edges.

The coupling portion 27 couples the first rectangular portion 23 and the second rectangular portion 25. The width of the coupling portion 27 in the third direction D3 is formed to be narrower toward the first rectangular portion 23. The coupling portion 27 includes a pair of edges 45a and 45b located on opposite sides in the third direction D3. Each of the pair of edges 45a and 45b is, for example, a straight line. The pair of edges 45a and 45b is, for example, inclined with respect to each other. Each of the pair of edges 45a and 45b extends in the second direction D2 so as to be inclined at a predetermined angle θ with respect to the second direction D2. In other words, each of the pair of edges 32a and 32b of the extended portion 12 is inclined with respect to the second direction D2 in the coupling portion 27. The angle θ is, for example, 57° or more and 80° or less.

The distance L1 from the end surface 3e to the main body portion 11 of the internal electrode 7 in the second direction D2 is smaller than the distance L2 from the edge of the external electrode 5 to the end surface 3e in the second direction D2. The distance L1 from the end surface 3f to the main body portion 11 of the internal electrode 9 in the second direction D2 is smaller than the distance L2 from the edge of the external electrode 6 to the end surface 3f in the second direction D2. In the second direction D2, the distance L1 from the end surface 3e to the main body portion 11 of the internal electrode 7 corresponds to the sum of the length Lg1 of the second rectangular portion 25 of each of the internal electrodes 7 and 9, the length Lg2 of the coupling portion 27, and the length Lg3 of the first rectangular portion 23.

The distance L1 corresponds to, for example, the maximum distance from the end surface 3e to the main body portion 11 of the internal electrode 7 in the second direction D2, or the maximum distance from the end surface 3f to the main body portion 11 of the internal electrode 9 in the second direction D2. The distance L2 corresponds to, for example, the maximum distance from the edge of the external electrode 5 to the end surface 3e, or the distance from the edge of the external electrode 6 to the end surface 3e. The length Lg1 corresponds to the maximum length of the second rectangular portion 25 of each of the internal electrodes 7 and 9 in the second direction D2. The length Lg2 corresponds to the maximum length of the coupling portion 27 of each of the internal electrodes 7 and 9 in the second direction D2. The length Lg3 corresponds to the maximum length of the first rectangular portion 23 of each of the internal electrodes 7 and 9 in the second direction D2.

In the second direction D2, the length Lg1 of the second rectangular portion 25 of each of the internal electrodes 7 and 9 is, for example, 0.04 mm or more and 0.13 mm or less. In the second direction D2, the length Lg2 of the coupling portion 27 of each of the internal electrodes 7 and 9 is, for example, 0.035 mm or more and 0.13 mm or less. In the second direction D2, the length Lg3 of the first rectangular portion 23 of each of the internal electrodes 7 and 9 is, for example, 0.08 mm or more and 0.18 mm or less.

Next, effects of the electronic component 1 according to the present embodiment and modifications will be described.

In the electronic component 1, the extended portion 12 includes the first rectangular portion 23, the second rectangular portion 25, and the coupling portion 27 described above. In this case, while the area of the main body portion 11 is secured, in the third direction D3, the width of the connection portion between the extended portion 12 and each of the external electrodes 5 and 6 is smaller than the width of the main body portion 11. Moreover, when a thermal shock occurs in the electronic component 1, the stress applied to the element body 3 in the vicinity of the extended portion 12 and the main body portion 11 is reduced by the second rectangular portion 25 and the coupling portion 27. As a result, the occurrence of cracks in the element body 3 can be prevented while the electrostatic capacitance is secured.

As a result of research and study, the present inventors have found that in an electronic component having a shape in which the first rectangular portion 23 is directly connected to the main body portion 11, when a thermal shock occurs in the electronic component, the maximum principal stress applied to the element body 3 is generated in the vicinity of the extended portion 12 and the main body portion 11. However, in the electronic component 1 including the second rectangular portion 25 and the coupling portion 27, the stress applied to the element body 3 in the vicinity of the extended portion 12 and the main body portion 11 is reduced even when a thermal shock occurs in the electronic component 1.

The main body portion 11 includes a pair of first edges 31a and 31b. The pair of first edges 31a and 31b is located on opposite sides in the third direction D3 and extends along the second direction D2. The second rectangular portion 25 includes a pair of second edges 42a and 42b. The pair of second edges 42a and 42b is located on opposite sides in the third direction D3 and extends along the second direction D2. Each of pair of second edges 42a and 42b may be located on an extension line of a corresponding first edge among the pair of first edges 31a and 31b. In this case, the stress applied to the element body 3 in the vicinity of the connection portion between the main body portion 11 and the second rectangular portion 25 can be further reduced.

The first portion α1 is covered with the external electrode 5. The second portion α2 is continuous with the first portion α1 and exposed from the external electrode 5. The distance L1 from the end surface 3e to the main body portion 11 in the second direction D2 may be smaller than the distance L2 from the edge of the external electrode 5 to the end surface 3e in the second direction D2. In this case, the electrostatic capacitance can be improved while preventing cracks in the element body 3.

In a case where the maximum width of the first rectangular portion 23 in the third direction D3 is H2 and the maximum width of the second rectangular portion 25 in the third direction D3 is H1, H2/H1 may be 0.6 or more and 0.8 or less. In this case, entry of moisture into the element body 3 can be further prevented.

The length Lg1 of the second rectangular portion 25 in the second direction D2 may be 0.04 mm or more and 0.13 mm or less. In this case, the stress applied to the element body 3 is further reduced, and cracks in the element body 3 can be further prevented.

The pair of edges 45a and 45b of the coupling portion 27 is located on opposite sides in the third direction D3. Each of the pair of edges 45a and 45b may extend in the second direction D2 so as to be inclined at 57° or more and 80° or less with respect to the second direction D2. In this case, the stress applied to the element body 3 is further reduced, and cracks in the element body 3 can be further prevented.

In the second direction D2, the length Lg3 of the first rectangular portion 23 may be 0.08 mm or more. In this case, the stress applied to the element body 3 is further reduced, and cracks in the element body 3 can be further prevented.

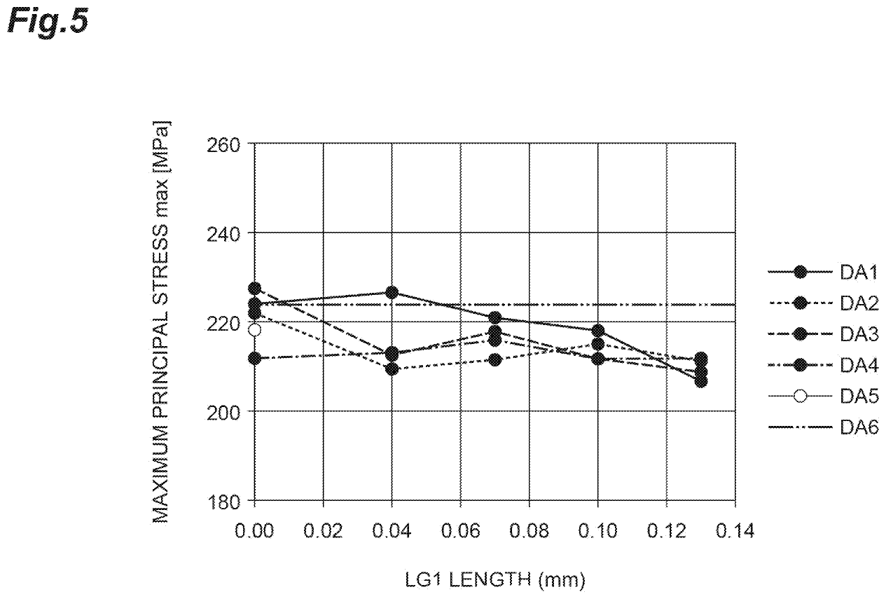

Next, an example of verification of an electronic component according to the present embodiment will be described with reference to FIGS. 5 to 10. In this verification, the internal stress distribution of the electronic component 1 in the thermal shock test has been simulated. In this verification, ANSYS2023R2/Mechanical has been used as a tool for simulating the internal stress of the electronic component 1 in a static structural analysis mode. In this verification, the electronic component 1 has been meshed using the finite element method (FEM), and the stress distribution between the elements has been calculated.

In this verification, the material and its characteristics have been set for each of portions P1, P2, P3, and P4 in the portion where the external electrodes 5 and 6 have been removed from the electronic component 1, and the stress applied to the inside of the element body 3 has been verified. The portion P1 and the portion P2 are portions formed only of the element body 3. The portion P3 is a portion configured by the main body portion 11 and the element body 3, and is a portion in which the main body portion 11 and the element body 3 are alternately disposed. The portion P4 is a portion configured by the extended portion 12 and the element body 3, and is a portion in which the extended portion 12 and the element body 3 are alternately disposed.

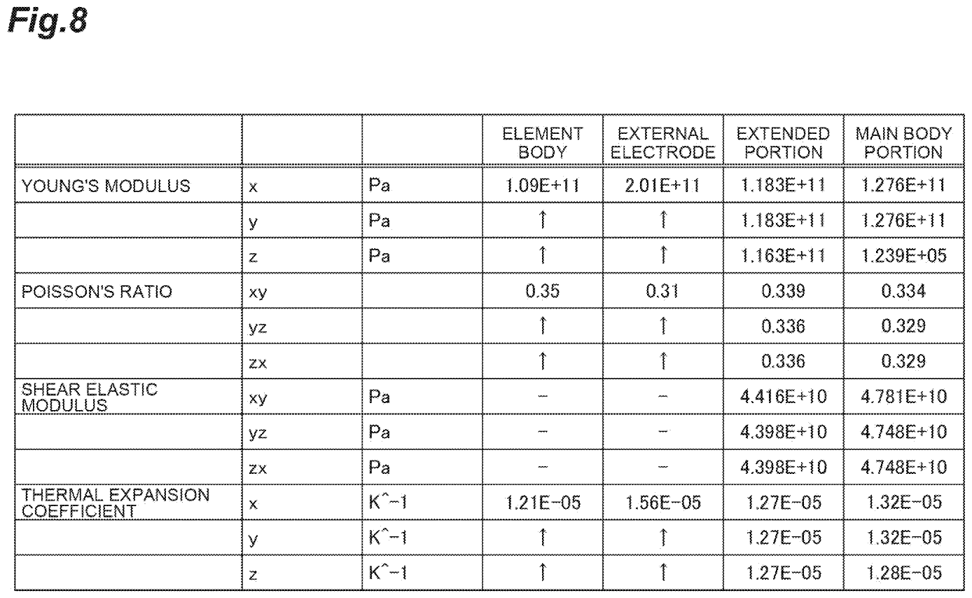

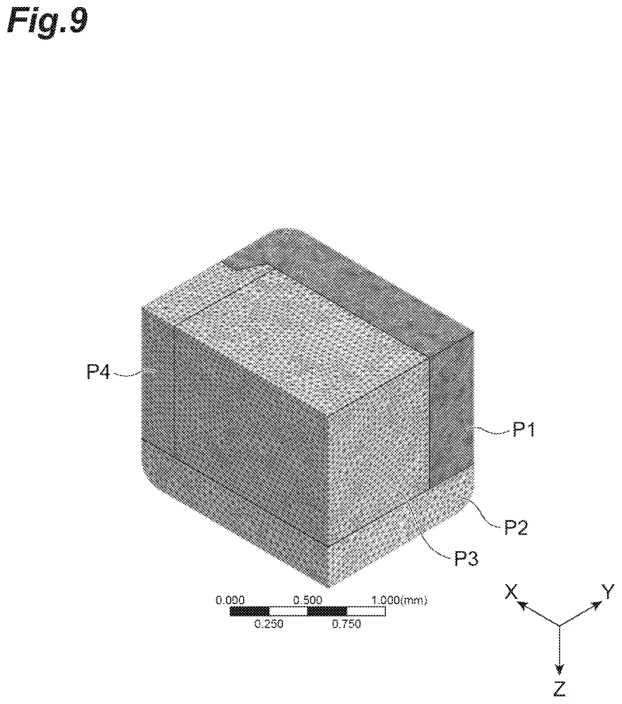

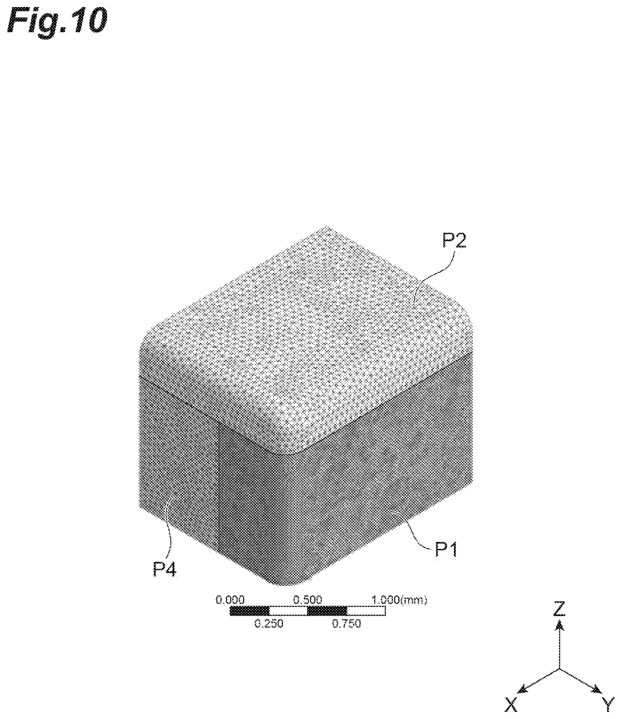

In this verification, the temperature difference has been set to 1228 degrees as a thermal load, the length Lg1 of the second rectangular portion 25 has been set to 0.4 mm, and the length Lg2 of the coupling portion 27 has been set to 0.7 mm. FIG. 8 is a table showing physical property values of the element body 3, the external electrodes 5 and 6, the main body portion 11, and the extended portion 12 in the electronic component 1 in this verification. FIGS. 9 and 10 show a part of the electronic component 1 divided into four from which the external electrodes 5 and 6 have been removed. In this verification, the mesh size of each of the portions P1, P2, P3, and P4 has been set as follows. The mesh size is the size of elements that divide an object in a simulation using the finite element method (FEM).

The mesh size of the portion P1 has been set to 2.4×10⁻² mm, the mesh size of the portion P2 has been set to 4.8×10⁻² mm, the mesh size of the portion P3 has been set to 4.5×10⁻² mm, and the mesh size of the portion P4 has been set to 4.5×10⁻² mm. These mesh sizes are based on such a size that at least five elements are included in the Gap direction. More specifically, in this verification, an element having an intermediate node is adopted, and the mesh size is set as a guide such that at least 10 nodes are included in the Gap direction. The GAP direction refers to a direction in which opening and closing of a gap (GAP) between adjacent elements occurs in contact analysis or clearance analysis.

FIG. 5 is a graph illustrating a relationship between the length Lg1 of the second rectangular portion 25 and the maximum principal stress applied to the element body 3. In FIG. 5, data DA1 is data in a case where the angle θ is 90°, data DA2 is data in a case where the angle θ is 78.5°, data DA3 is data in a case where the angle θ is 70.4°, and data DA4 is data in a case where the angle θ is 63.1°. Data DA5 is data in a case where the width of the extended portion 12 in the third direction D3 is the same as the width H1 of the main body portion 11 and the extended portion 12 extends to the end surface 3e. Data DA6 is data in a case where the first rectangular portion 23 is directly connected to the main body portion 11. According to the verification result illustrated in FIG. 5, it has been confirmed that the maximum principal stress applied to the element body 3 is reduced in a case where the length Lg1 of the second rectangular portion 25 in the second direction D2 is 0.04 mm or more and 0.13 mm or less.

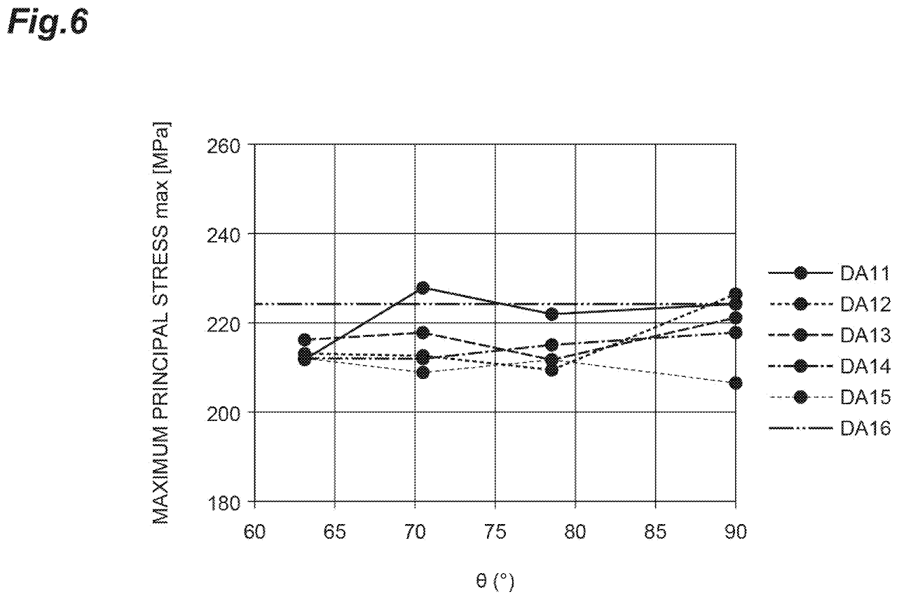

FIG. 6 is a graph illustrating a relationship between the gradient of the coupling portion 27 and the maximum principal stress applied to the element body 3. In FIG. 6, data DA11 is data in a case where the length Lg1 is 0.00, data DA12 is data in a case where the length Lg1 is 0.04, data DA13 is data in a case where the length Lg1 is 0.07, data DA14 is data in a case where the length Lg1 is 0.10, and data DA15 is data in a case where the length Lg1 is 0.13. Data DA16 is data in a case where the first rectangular portion 23 is directly connected to the main body portion 11. According to the verification result illustrated in FIG. 6, it has been confirmed that the maximum principal stress applied to the element body 3 is reduced in a case where the second rectangular portion 25 is present and each of the pair of edges 45a and 45b of the coupling portion 27 is inclined at 57° or more and 80° or less with respect to the second direction D2.

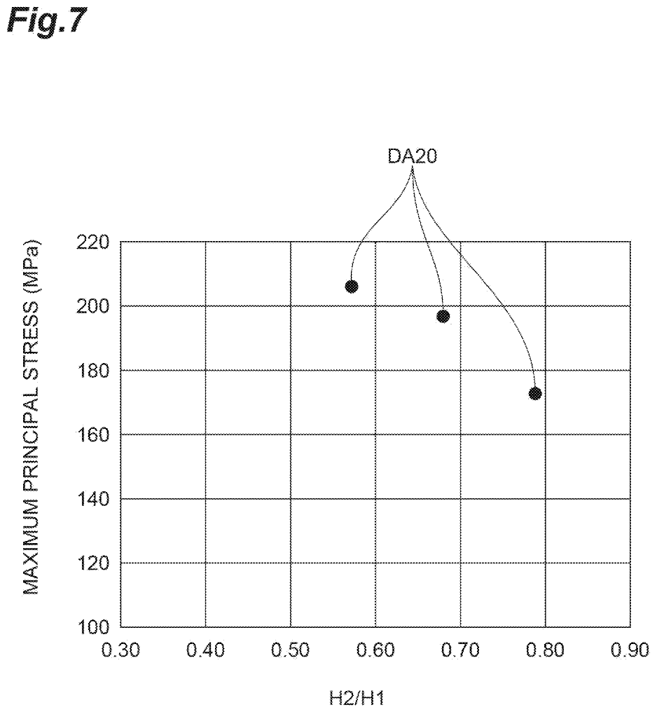

FIG. 7 is a graph illustrating a relationship between the drawing ratio H2/H1 and the maximum principal stress applied to the element body. As described above, the maximum width of the first rectangular portion 23 in the third direction D3 is H2, and the maximum width of the second rectangular portion 25 in the third direction D3 is H1. According to the data DA20, it has been confirmed that the maximum principal stress applied to the element body 3 is reduced to 220 MPa or less in a case where H2/H1 is 0.6 or more and 0.8 or less.

Although the embodiment and modifications of the present disclosure have been described above, the present disclosure is not necessarily limited to the above-described examples, and various modifications can be made without departing from the sprit and scope thereof.

For example, although the electronic component 1 described above includes the pair of external electrodes 5 and 6, the electronic component of the present disclosure may include one or more external electrode other than the external electrodes 5 and 6. The electronic component of the present disclosure may include one or more internal electrode other than the internal electrodes 7 and 9.

1. An electronic component comprising:
an element body;
first and second internal electrodes provided inside the element body and opposed to each other in a first direction;
a first external electrode provided outside the element body and electrically connected to the first internal electrode; and
a second external electrode provided outside the element body separately from the first external electrode and electrically connected to the second internal electrode, wherein
the first internal electrode includes: a main body portion overlapping the second internal electrode in the first direction; and an extended portion not overlapping the second internal electrode when viewed from the first direction, extending in a second direction intersecting the first direction, and coupling the first external electrode and the main body portion, and
the extended portion includes:
a first rectangular portion coupled to the first external electrode and having a rectangular shape;
a second rectangular portion coupled to the main body portion and having a rectangular shape; and
a coupling portion coupling the first rectangular portion and the second rectangular portion, wherein
a width of the first rectangular portion is smaller than a width of the main body portion in a third direction intersecting the first and second directions,
a width of the second rectangular portion is larger than a width of the first rectangular portion in the third direction, and
a width of the coupling portion in the third direction is formed to be narrower toward the first rectangular portion.

2. The electronic component according to claim 1, wherein
the main body portion includes a pair of first edges located on opposite sides in the third direction and extending along the second direction, and
the second rectangular portion includes a pair of second edges located on opposite sides in the third direction and extending along the second direction, and
each of the pair of second edges is located on an extension line of a corresponding first edge among the pair of first edges.

3. The electronic component according to claim 1, wherein
the element body includes first and second end surfaces opposed to each other in the second direction, and a side surface extending in the second direction and located between the first end surface and the second end surface when viewed from a direction orthogonal to the second direction, and
the first external electrode is provided on the first end surface and the side surface, is coupled to the first rectangular portion at the first end surface, and extends from the first end surface toward the second end surface at the side surface, and
the side surface includes a first portion covered with the first external electrode and a second portion continuous with the first portion and exposed from the first external electrode, and
a shortest distance from the first end surface to the main body portion in the second direction is smaller than a shortest distance from the first end surface to a boundary between the first portion and the second portion in the second direction.

4. The electronic component according to claim 1, wherein
in a case where a maximum width of the first rectangular portion in the third direction is H2 and a maximum width of the second rectangular portion in the third direction is H1, H2/H1 is 0.6 or more and 0.8 or less.

5. The electronic component according to claim 1, wherein
a maximum length of the second rectangular portion in the second direction is 0.04 mm or more and 0.13 mm or less.

6. The electronic component according to claim 1, wherein
the coupling portion includes a pair of edges located on opposite sides in the third direction and each extending in the second direction so as to be inclined at 57° or more and 80° or less with respect to the second direction.

7. The electronic component according to claim 1, wherein
a maximum length of the first rectangular portion in the second direction is 0.08 mm or more.
